(19) United States
(12) Patent Application Publication
(10) Pub. No.: US 2023/0249688 A1
(43) Pub. Date: Aug. 10, 2023

(54) VEHICLE CONTROL DEVICE, AUTONOMOUS DISTRIBUTED TRAFFIC CONTROL SYSTEM, AND VEHICLE CONTROL METHOD

(71) Applicant: Mitsubishi Electric Corporation, Tokyo (JP)

(72) Inventors: Toshihide SATAKE, Tokyo (JP); Yoshiki KANDA, Tokyo (JP); Hiroshi YAMADA, Tokyo (JP); Toru HIGUCHI, Tokyo (JP); Haiyue ZHANG, Tokyo (JP); Takatoshi KAKUTA, Tokyo (JP); Kohei MORI, Tokyo (JP); Takayuki TANAKA, Tokyo (JP)

(73) Assignee: Mitsubishi Electric Corporation, Tokyo (JP)

(21) Appl. No.: 18/096,199

(22) Filed: Jan. 12, 2023

(30) Foreign Application Priority Data
Feb. 8, 2022 (JP) 2022-017648

(51) Int. Cl. B60W 30/18; B60W 60/00

(52) U.S. Cl. CPC B60W 30/18154; B60W 60/001; B60W 2556/40; B60W 2552/05; B60W 2554/4042; B60W 2554/4041

(57) ABSTRACT

A vehicle control device includes: an ego-vehicle information acquisition unit which acquires ego-vehicle information; a map information acquisition unit which acquires map information about an intersection; an other-vehicle information acquisition unit which acquires other-vehicle information about another vehicle traveling on a road connected to the intersection; an intersection entry possibility determination unit which calculates a stop time of the other vehicle at a position of a stop line for the intersection, calculates a stop time of the ego vehicle at a position of a stop line for the intersection, and determines whether or not the ego vehicle is allowed to enter the intersection on the basis of the stop time of the other vehicle and the stop time of the ego vehicle; and a vehicle control unit which controls traveling of the ego vehicle at the intersection.

### BACKGROUND OF THE DISCLOSURE

### 1. Field of the Disclosure

The present disclosure relates to a vehicle control device, an autonomous distributed traffic control system, and a vehicle control method.

### 2. Description of the Background Art

In recent years, a centralized control type and an autonomous distributed type have been proposed as traffic control systems using autonomous driving. In the traffic control system of the centralized control type, a traffic control center recognizes the states of all autonomous driving vehicles present in a control area, and also at an intersection, the traffic control center performs adjustment for the autonomous driving vehicles so that all vehicles including the autonomous driving vehicles will not collide with each other. Then, the traffic control center transmits commands about the traveling speeds and the like to the autonomous driving vehicles, thereby establishing smooth traffic.

On the other hand, in the autonomous distributed traffic control system, using map information included in each autonomous driving vehicle and other-vehicle information provided from outside of the ego vehicle such as detected information from a surrounding detection sensor, each vehicle autonomously determines operation that the ego vehicle should perform, in accordance with the surrounding traffic environment, thereby traveling so as to avoid collision between vehicles. As compared to the traffic control system of the centralized control type, the autonomous distributed traffic control system does not need large-scale equipment such as a traffic control center and thus has an advantage that an autonomous driving traffic control system can be established at low cost.

According to an operation planning device described in Patent Document 1, it is proposed that, in an autonomous distributed traffic control system, when an autonomous driving vehicle is about to enter an intersection, the autonomous driving vehicle determines operation for avoiding collision with an obstacle such as another vehicle on the basis of a detection result for the present position of the obstacle, for example. Specifically, whether or not there is an obstacle in a determination area preset so as to cover the intersection is determined, and if there is an obstacle in the determination area, the ego vehicle stops once before entering the intersection. Then, after the obstacle goes out of the determination area, the ego vehicle enters the intersection.

Patent Document 1: Japanese Patent No. 6908211 However, regarding the operation planning device described in Patent Document 1, for example, it is assumed that a vehicle A is traveling from north to south in a general crossroad intersection with each road having one lane in each direction, i.e., two lanes in respective directions, and a vehicle B to travel from east to west is waiting around the intersection for the vehicle A to pass. Further, a vehicle C to travel from west to east arrives at the intersection and waits for the vehicle A to pass, as with the vehicle B. In this case, there is a possibility that, after the vehicle A passes, both of the vehicle B and the vehicle C cannot enter the intersection and therefore cannot pass, resulting in so-called deadlock.

### SUMMARY OF THE DISCLOSURE

The present disclosure has been made to solve the above problem and an object of the present disclosure is to provide a vehicle control device, an autonomous distributed traffic control system, and a vehicle control method that can achieve smooth traffic at an intersection.

A vehicle control device according to the present disclosure includes: an ego-vehicle information acquisition unit which acquires ego-vehicle information including at least an ego-vehicle position; a map information acquisition unit which acquires map information about an intersection; an other-vehicle information acquisition unit which acquires other-vehicle information about another vehicle traveling on a road connected to the intersection, in a preset range from the intersection; an intersection entry possibility determination unit which calculates a stop time of the other vehicle at a position of a stop line for the intersection on the basis of the map information and the other-vehicle information, calculates a stop time of the ego vehicle at a position of a stop line for the intersection on the basis of the ego-vehicle position, and determines whether or not the ego vehicle is allowed to enter the intersection on the basis of the stop time of the other vehicle and the stop time of the ego vehicle; and a vehicle control unit which controls traveling of the ego vehicle at the intersection on the basis of the determination by the intersection entry possibility determination unit.

An autonomous distributed traffic control system according to the present disclosure includes: the above vehicle control device; a traffic environment recognition device which is provided around the intersection and acquires traffic information about each vehicle traveling on the road connected to the intersection in the preset range from the intersection; and a traffic information distribution device which is provided around the intersection, receives the traffic information transmitted from the traffic environment recognition device, and distributes, to each vehicle, vehicle information about the respective vehicles generated on the basis of the traffic information.

A vehicle control method according to the present disclosure includes: an ego-vehicle information acquisition step of acquiring ego-vehicle information including at least an ego-vehicle position; a map information acquisition step of acquiring map information about an intersection; an other-vehicle information acquisition step of acquiring other-vehicle information about another vehicle traveling on a road connected to the intersection, in a preset range from the intersection; an intersection entry possibility determination step of calculating a stop time of the other vehicle at a position of a stop line for the intersection on the basis of the map information and the other-vehicle information, calculating a stop time of the ego vehicle at a position of a stop line for the intersection on the basis of the ego-vehicle position, and when the other vehicle is not present in the intersection and a stop time of the other vehicle is shorter than a stop time of the ego vehicle, determining that the ego vehicle is to enter the intersection; and a vehicle control step of controlling traveling of the ego vehicle at the intersection on the basis of the determination in the intersection entry possibility determination step.

With the vehicle control device and the autonomous distributed traffic control system according to the present disclosure, in traveling of vehicles at an intersection, whether or not the ego vehicle is allowed to enter the intersection is determined on the basis of the ego-vehicle information and the other-vehicle information, thus providing an effect of obtaining a vehicle control device and an autonomous distributed traffic control system that can achieve smooth traffic at the intersection.

With the vehicle control method according to the present disclosure, in traveling of vehicles at an intersection, whether or not the ego vehicle is allowed to enter the intersection is determined on the basis of the ego-vehicle information and the other-vehicle information, thus providing an effect of achieving smooth traffic at the intersection.

### BRIEF DESCRIPTION OF THE DRAWINGS

FIG. 1 is a conceptual diagram showing an autonomous distributed traffic control system according to the first embodiment of the present disclosure;

FIG. 2 is a function block diagram showing the configuration of a vehicle control device according to the first embodiment;

FIG. 3 schematically shows an autonomous driving vehicle provided with the vehicle control device according to the first embodiment;

FIG. 4 is a flowchart illustrating a vehicle control method according to the first embodiment;

FIG. 5 shows an example of other-vehicle information in the autonomous distributed traffic control system according to the first embodiment;

FIG. 6 schematically illustrates the definitions of entry priorities of respective entrances at an intersection, in a vehicle control method according to the second embodiment of the present disclosure;

FIG. 7 is a flowchart illustrating the vehicle control method according to the second embodiment;

FIG. 8 is a conceptual diagram showing an autonomous distributed traffic control system according to the third embodiment of the present disclosure;

FIG. 9 shows an example of ego-vehicle information according to the third embodiment;

FIG. 10 is a function block diagram showing the configuration of a vehicle control device according to the third embodiment;

FIG. 11 shows an example of other-vehicle information in the vehicle control device according to the third embodiment;

FIG. 12 is a flowchart illustrating a vehicle control method according to the third embodiment;

FIG. 13 shows an example of hardware of the vehicle control device and the autonomous distributed traffic control system according to each of the first to third embodiments.

### DETAILED DESCRIPTION OF THE PREFERRED EMBODIMENTS OF THE DISCLOSURE

### First Embodiment

### Configurations of Vehicle Control Device and Autonomous Distributed Traffic Control System According to First Embodiment

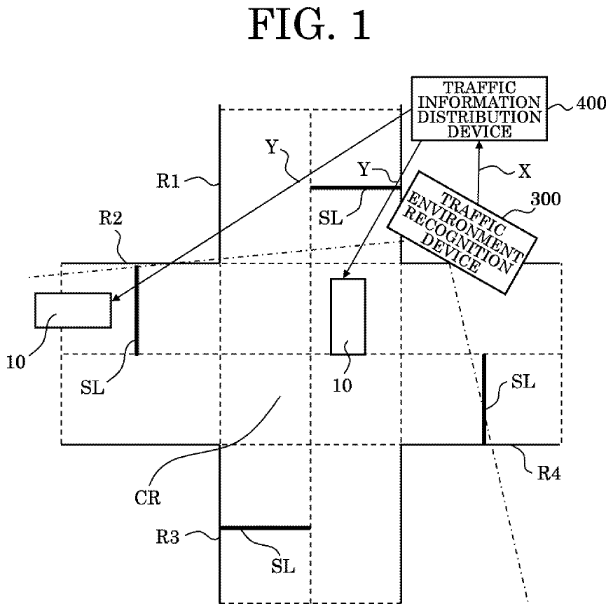

A vehicle control device and an autonomous distributed traffic control system according to the first embodiment of the present disclosure will be described with reference to FIG. 1 to FIG. 4. FIG. 1 is a conceptual diagram showing an autonomous distributed traffic control system 1000 according to the first embodiment. The autonomous distributed traffic control system 1000 includes vehicle control devices 200 provided to autonomous driving vehicles 10, a traffic environment recognition device 300 installed on a roadside of an intersection CR or the like, and a traffic information distribution device 400 which distributes other-vehicle information Y to each of the autonomous driving vehicles 10 traveling on the intersection CR and around the intersection CR on the basis of traffic information X distributed from the traffic environment recognition device 300 via a wire or wirelessly. That is, the autonomous distributed traffic control system 1000 according to the first embodiment includes the vehicle control device 200, the traffic environment recognition device 300, and the traffic information distribution device 400.

In the conceptual diagram shown in FIG. 1, only one traffic environment recognition device 300 is installed on a roadside of the intersection CR. However, a plurality of traffic environment recognition devices 300 may be installed on a roadside of one intersection, the traffic information distribution device 400 may integrate traffic information X distributed from the plurality of traffic environment recognition devices 300 and distribute other-vehicle information Y to each of the autonomous driving vehicles 10.

The traffic environment recognition device 300 is provided with a camera, a radar, a communication device (which are not shown), and the like. In a recognition range S of the traffic environment recognition device 300, i.e., in a range indicated by dotted-dashed lines in FIG. 1, the traffic environment recognition device 300 acquires, in real time, information about the intersection CR and information about traffic such as the numbers, the shapes, the positions, and the traveling speeds of the autonomous driving vehicles which are traveling, stopped, or waiting at the intersection CR and around the intersection CR, and distributes the information about traffic as traffic information X to the traffic information distribution device 400. That is, the traffic environment recognition device 300 installed on the roadside acquires information about each autonomous driving vehicle 10 traveling on a road connected to the intersection CR, in a preset range from the intersection CR (in the recognition range S).

Actual examples of the intersection CR include various types. An example of the intersection CR in the first embodiment is a crossroad where roads each having two lanes (i.e., two autonomous driving vehicles 10 can be placed in the width direction) cross each other. That is, four roads are connected to the intersection CR. In the conceptual diagram shown in FIG. 1, a road on the upper side in FIG. 1 is defined as a road R1, a road on the left side is defined as a road R2, a road on the lower side is defined as a road R3, and a road on the right side is defined as a road R4. On the roads R1, R2, R3, R4, stop lines SL are provided at positions separated from the intersection CR by predetermined distances. In the example of the first embodiment, each autonomous driving vehicle 10 travels on the left side with respect to the advancing direction on the two-lane road. Therefore, the stop line SL is provided on, of the two lanes, the left lane corresponding to the advancing direction.

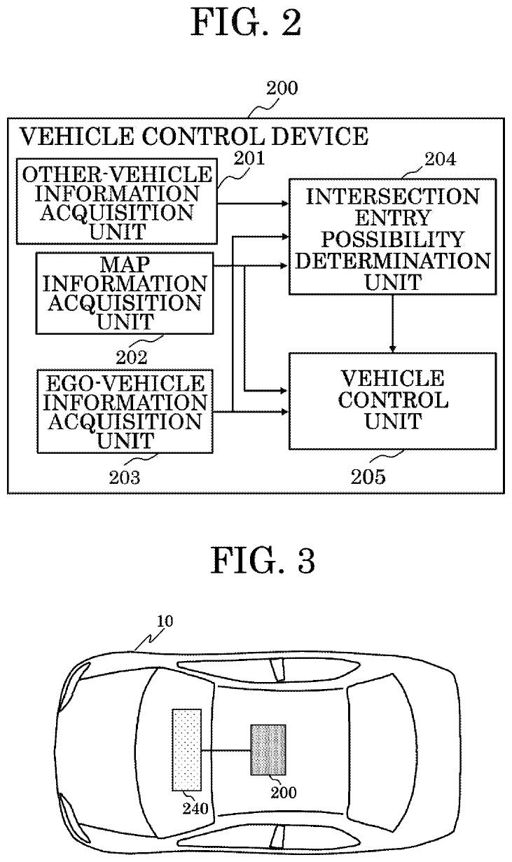

FIG. 2 is a function block diagram showing the configuration of the vehicle control device 200 provided to the autonomous driving vehicle 10. FIG. 3 schematically shows the autonomous driving vehicle 10 provided with the vehicle control device 200.

The vehicle control device 200 includes an other-vehicle information acquisition unit 201, a map information acquisition unit 202, an ego-vehicle information acquisition unit 203, an intersection entry possibility determination unit 204, and a vehicle control unit 205. As shown in FIG. 3, the vehicle control device 200 is provided to the autonomous driving vehicle 10. The vehicle control device 200 calculates a target steering amount and a target acceleration/deceleration needed for reaching a target point along a target route, and outputs the target steering amount and the target acceleration/deceleration to an actuator unit 240.

The other-vehicle information acquisition unit 201 acquires the other-vehicle information Y distributed from the traffic information distribution device 400 shown in FIG. 1. It is noted that, if the ego-vehicle position and the orientation of the ego vehicle detected by the traffic environment recognition device 300 can be acquired via the other-vehicle information Y, ego-vehicle information Z included in the other-vehicle information Y may be used instead of the ego-vehicle information acquisition unit 203 described later. In this case, the ego vehicle need not be provided with devices such as a sensor and the like needed for acquiring the ego-vehicle information Z, thus providing an effect of reducing the cost for the entire vehicle.

The map information acquisition unit 202 stores map information M in advance in a map information database (not shown) in the ego vehicle. The map information acquisition unit 202 may acquire and update the map information M from outside of the ego vehicle as necessary.

The ego-vehicle information acquisition unit 203 acquires the ego-vehicle information Z such as the ego-vehicle position and the orientation which are position information of the ego vehicle. The ego-vehicle information Z includes the state quantity of the ego vehicle which represents the state of the ego vehicle. The ego-vehicle information acquisition unit 203 acquires the ego-vehicle information Z needed for traveling of the ego vehicle based on autonomous driving, using sensors provided to the ego vehicle such as a GNSS sensor, a yaw rate sensor, a velocity sensor, an acceleration sensor, a steering angle sensor, and a steering torque sensor (which are not shown), for example. The ego-vehicle information Z and the other-vehicle information Y described above are collectively referred to as vehicle information. For example, from the standpoint of the traffic information distribution device 400, there are no differences in the traveling vehicles between an ego vehicle and another vehicle, and therefore pieces of information distributed to the traveling vehicles are all vehicle information.

The intersection entry possibility determination unit 204 determines, at the intersection CR on the traveling route, whether or not the ego vehicle is allowed to enter the intersection CR, on the basis of the other-vehicle information Y acquired by the other-vehicle information acquisition unit 201 and the map information M about the intersection CR acquired by the map information acquisition unit 202 and also on the basis of stop times of the ego vehicle and another vehicle at the positions of the stop lines SL provided on the intersection CR. The determination method will be described later.

The vehicle control unit 205 executes vehicle control needed for the ego vehicle to travel by autonomous driving to the target point along the target route set by the target route setting unit (not shown) according to the target point, on the basis of the map information M acquired by the map information acquisition unit 202 and the ego-vehicle information Z acquired by the ego-vehicle information acquisition unit 203. In addition, when the ego vehicle is to pass the intersection, the vehicle control unit 205 performs vehicle control for traveling of the ego vehicle at the intersection, by referring to determination of the intersection entry possibility determination unit 204.

### Operations of Vehicle Control Device and Autonomous Distributed Traffic Control System According to First Embodiment

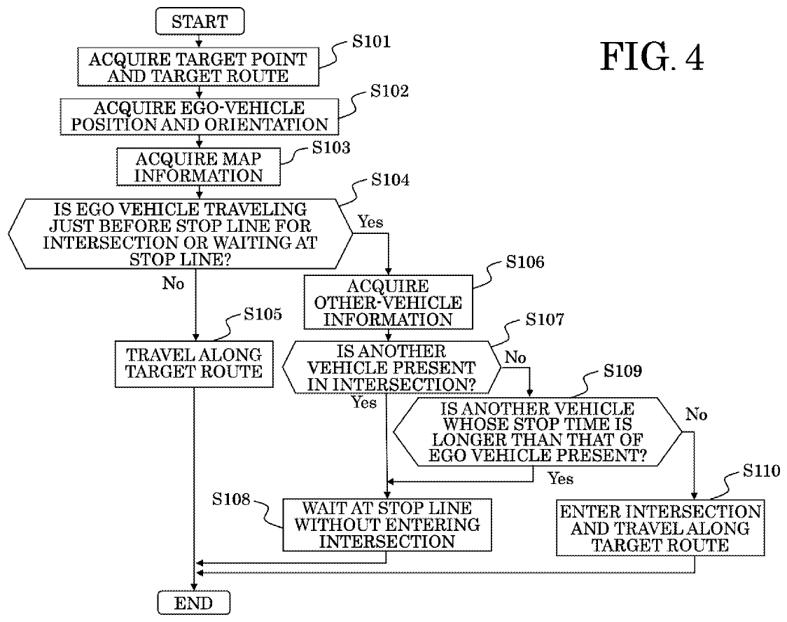

Regarding the vehicle control device 200 and the autonomous distributed traffic control system 1000 according to the first embodiment, operation when the autonomous driving vehicle 10 travels along the target route including the intersection CR to the target point will be described below. FIG. 4 is a flowchart showing operation to be repeatedly executed per certain cycle by the autonomous driving vehicle 10 provided with the vehicle control device 200 according to the first embodiment under vehicle control by the vehicle control device 200. That is, FIG. 4 is a flowchart illustrating the vehicle control method according to the first embodiment.

In step S101, the vehicle control unit 205 acquires the target point and the target route for the ego vehicle to go. The target point is set through input from an occupant of the ego vehicle by means of an input device (not shown) in the ego vehicle, for example. Using the target point and the map information M, a preferred target route for reaching the target point is automatically generated by a known traveling route generation method. Alternatively, as with the target point, the occupant may input the target route to the input device (not shown).

In step S102, the vehicle control unit 205 and the intersection entry possibility determination unit 204 acquire the ego-vehicle position and the orientation from the ego-vehicle information acquisition unit 203.

In step S103, the intersection entry possibility determination unit 204 acquires the map information M about the intersection CR through which the ego vehicle will pass, from the map information acquisition unit 202.

In step S104, the intersection entry possibility determination unit 204 determines whether or not the ego vehicle is traveling to the stop line SL for the intersection CR or is stopped or waiting at the position of the stop line SL, in the recognition range S of the traffic environment recognition device 300. If, in the recognition range S, the ego vehicle is not traveling to the stop line SL for the intersection CR and is not stopped or waiting at the position of the stop line SL (in case of No), the process proceeds to step S105 and the vehicle control unit 205 performs vehicle control so that the ego vehicle travels along the target route, thus ending the present process. In the above description, the position of the stop line SL means not only the position of the stop line SL itself but also a position considered appropriate for the vehicle to stop or wait even if the position is before the stop line SL, in the recognition range S.

On the other hand, in step S104, if the ego vehicle is traveling to the stop line SL for the intersection or is stopped or waiting at the position of the stop line SL in the recognition range S (in case of Yes), the process proceeds to step S106.

In step S106, the intersection entry possibility determination unit 204 acquires the other-vehicle information Y from the other-vehicle information acquisition unit 201, and the process proceeds to step S107.

In step S107, the intersection entry possibility determination unit 204 determines whether or not another vehicle is present in the intersection CR. If another vehicle is present in the intersection CR (in case of Yes), the process proceeds to step S108 and the vehicle control unit 205 performs vehicle control so that the ego vehicle stops or waits at the position of the stop line SL without entering the intersection CR, thus ending the present process.

In step S107, if another vehicle is not present in the intersection CR (in case of No), the process proceeds to step S109. In step S109, the intersection entry possibility determination unit 204 determines whether or not another vehicle whose stop time is longer than the stop time of the ego vehicle at the position of the stop line SL is present around the intersection CR, on the basis of the map information M around the intersection CR acquired by the map information acquisition unit 202, the ego-vehicle position and the orientation acquired by the ego-vehicle information acquisition unit 203, and the other-vehicle information Y acquired by the other-vehicle information acquisition unit 201. The stop time includes not only a time during which the vehicle has been stopped but also a waiting time during which the vehicle has been waiting.

In step S109, if another vehicle whose stop time is longer than the stop time of the ego vehicle at the position of the stop line SL is present around the intersection CR (in case of Yes), the vehicle control unit 205 performs vehicle control so that the ego vehicle stops or waits at the position of the stop line SL without entering the intersection CR, thus ending the present process.

On the other hand, if another vehicle whose stop time is longer than the stop time of the ego vehicle at the position of the stop line SL is not present around the intersection CR (in case of No), the process proceeds to step S110. In step S110, the vehicle control unit 205 performs vehicle control so that the ego vehicle enters the intersection CR and travels along the target route to the target point, thus ending the present process.

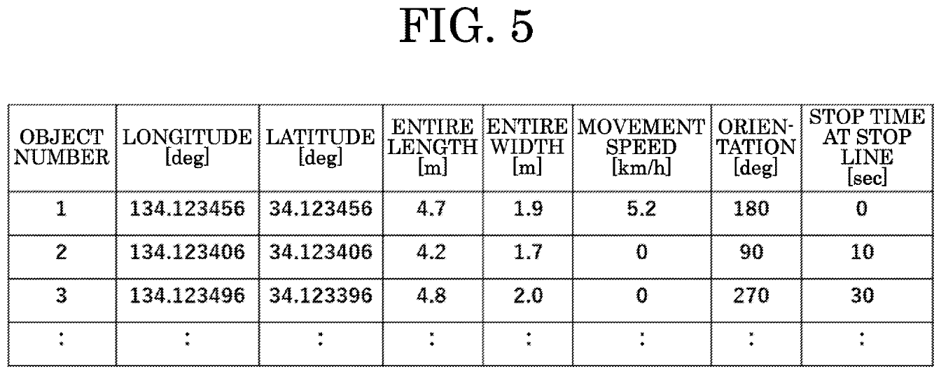

In the operation of the vehicle control device 200 described above, when the autonomous driving vehicle 10 is to enter the intersection CR, the intersection entry possibility determination unit 204 determines whether or not another vehicle whose stop time is longer than the stop time of the ego vehicle at the position of the stop line SL is present. For this determination, as in an example shown in FIG. 5, the other-vehicle information Y distributed from the traffic information distribution device 400 to the autonomous driving vehicle 10 includes not only the position information of each vehicle but also the stop time of each vehicle at the position of the stop line SL, i.e., a value indicating that the vehicle is stopped at present and how long the stop state has continued.

The stop time of the ego vehicle can be calculated by the intersection entry possibility determination unit 204 on the basis of the map information M about the intersection CR acquired by the map information acquisition unit 202 and the ego-vehicle position included in the ego-vehicle information Z acquired by the ego-vehicle information acquisition unit 203. Alternatively, the stop time of the ego vehicle at the position of the stop line SL may be calculated considering also the traveling speed of the ego vehicle.

All the autonomous driving vehicles 10 controlled by the autonomous distributed traffic control system 1000 according to the first embodiment operate as described above, whereby, at the intersection CR, the vehicles can enter the intersection CR in the order from the vehicle that has been stopped or waiting for the longest stop time. Thus, smooth traffic at the intersection can be achieved.

In the first embodiment, for facilitating the understanding, only a top vehicle at each entrance for the intersection CR is considered. A second or subsequent vehicle after the top vehicle may be assumed to always stop at the rear of the top vehicle, and the stop time at the position of the stop line SL may be considered including the stop time of stopping at the rear of the top vehicle, whereby more preferable control can be performed.

In the first embodiment, the traffic information distribution device 400 distributes the other-vehicle information Y to the autonomous driving vehicle 10, including the stop time of each vehicle at the position of the stop line SL around the intersection CR. Instead of such a method of using information of the stop time included in the other-vehicle information Y as described above, the stop time of each vehicle at the position of the stop line SL may be acquired by the following method.

The traffic information distribution device 400 stores the positions of the stop lines SL at the intersection CR, as the map information M in advance. The vehicle control device 200 receives the position information and the traveling speed information of each vehicle included in the other-vehicle information Y distributed from the traffic information distribution device 400, compares the positional relationships between the positions of the stop lines SL and the positions of the vehicles, and determines whether or not the traveling speed of each vehicle is zero, whereby the stop time of each vehicle at the position of the stop line SL can be calculated. Alternatively, while only the position information of each vehicle is received, the stop time of each vehicle at the position of the stop line SL can be calculated using the fact that the vehicle position has not changed.

In the first embodiment, the other-vehicle information Y distributed by the traffic information distribution device 400 is used only for determination by the intersection entry possibility determination unit 204. However, the other-vehicle information Y acquired by the vehicle control device 200 may be used also for traveling while avoiding an obstacle on the target route.

### Effects of First Embodiment

As described above, with the vehicle control device, the autonomous distributed traffic control system, and the vehicle control method according to the first embodiment, in traveling of vehicles at an intersection, whether or not the ego vehicle is allowed to enter the intersection is determined on the basis of the stop times of the ego vehicle and other vehicles, whereby the vehicles can enter the intersection in the order from the vehicle whose stop time is longest, thus providing an effect of achieving smooth traffic at the intersection.

### Second Embodiment

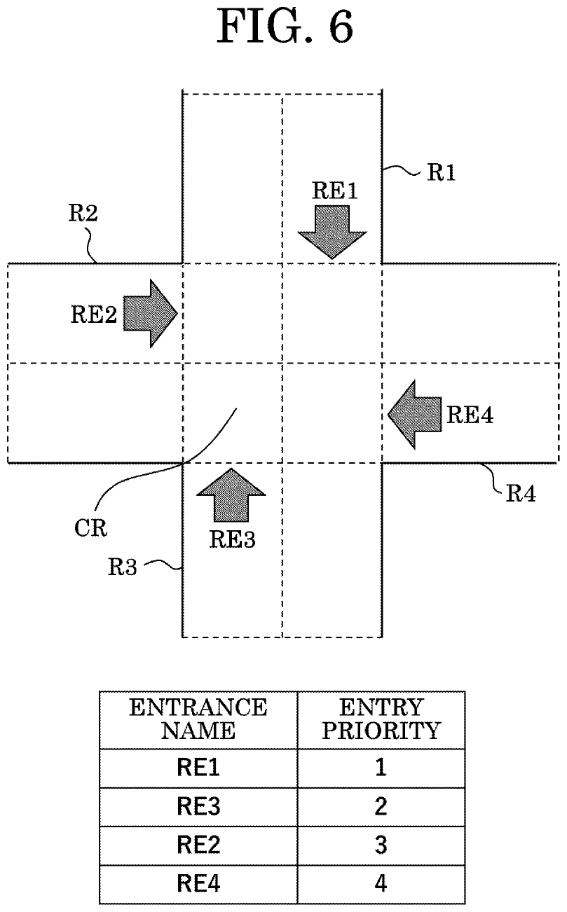

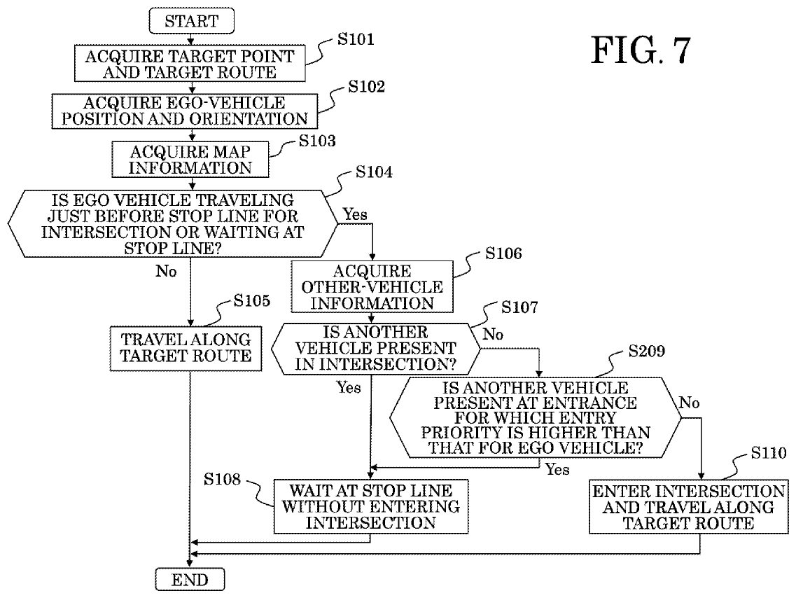

A vehicle control device, an autonomous distributed traffic control system, and a vehicle control method according to the second embodiment of the present disclosure will be described with reference to FIG. 6 and FIG. 7. FIG. 6 schematically illustrates the definitions of entry priorities of respective entrances at an intersection, in the vehicle control method according to the second embodiment. FIG. 7 is a flowchart illustrating the vehicle control method according to the second embodiment. A conceptual diagram showing the autonomous distributed traffic control system is the same as that in the first embodiment and therefore is omitted.

In the vehicle control method according to the second embodiment, map information M stored in the autonomous driving vehicle 10 and a determination method performed by the intersection entry possibility determination unit 204 are different from those in the first embodiment. In the second embodiment, the map information M stored in each of the vehicle control devices 200 provided to all the autonomous driving vehicles 10 controlled by the autonomous distributed traffic control system 1000 includes, as common information, entry priorities set in advance for each entrance, with respect to the respective entrances RE1, RE2, RE3, RE4 for the intersection CR, as shown in FIG. 6.

### Operations of Vehicle Control Device and Autonomous Distributed Traffic Control System According to Second Embodiment

In the vehicle control method according to the second embodiment, operation when the autonomous driving vehicle 10 travels along the target route including the intersection CR to the target point will be specifically described. FIG. 7 is a flowchart showing operation to be repeatedly executed per certain cycle by the vehicle control device 200 provided to the autonomous driving vehicle 10. In FIG. 7, the vehicle control method according to the second embodiment is different from the vehicle control method according to the first embodiment only in that processing in step S109 in the first embodiment is replaced with step S209 in the second embodiment. Hereinafter, only processing in step S209 will be described.

In step S209, in a case where, in the recognition range S of the traffic environment recognition device 300, the ego vehicle is traveling to the stop line SL for the intersection CR or is stopped or waiting at the position of the stop line SL, and where another vehicle is not present in the intersection CR, the intersection entry possibility determination unit 204 determines whether or not another vehicle is present at the entrance RE for which the entry priority is higher than that for the ego vehicle, on the basis of the map information M, the ego-vehicle position, and the other-vehicle information Y.

If another vehicle is present at the entrance RE for which the entry priority is higher than that for the entrance RE to the intersection CR on the road where the ego vehicle travels (in case of Yes), the process proceeds to step S108 and the vehicle control device 200 performs vehicle control so that the ego vehicle waits at the position of the stop line SL without entering the intersection CR, thus ending the process. On the other hand, if another vehicle is not present at the entrance RE for which the entry priority is higher than that for the ego vehicle (in case of No), the vehicle control device 200 performs vehicle control so that the ego vehicle enters the intersection CR and travels along the target route to the target point, thus ending the present process.

All the autonomous driving vehicles 10 controlled by the autonomous distributed traffic control system 1000 operate as described above, whereby, at the intersection, the vehicles can enter the intersection in the order from the vehicle waiting at the entrance RE for which the entry priority is higher. Thus, smooth traffic at the intersection can be achieved.

### Effects of Second Embodiment

As described above, with the vehicle control device, the autonomous distributed traffic control system, and the vehicle control method according to the second embodiment, in traveling of vehicles at an intersection, whether or not the ego vehicle is allowed to enter the intersection is determined on the basis of the entry priorities set in advance for respective entrances for the intersection, whereby, at the intersection, the vehicles can enter the intersection in the order from the vehicle waiting at the entrance for which the entry priority is higher, thus providing an effect of achieving smooth traffic at the intersection.

### Third Embodiment

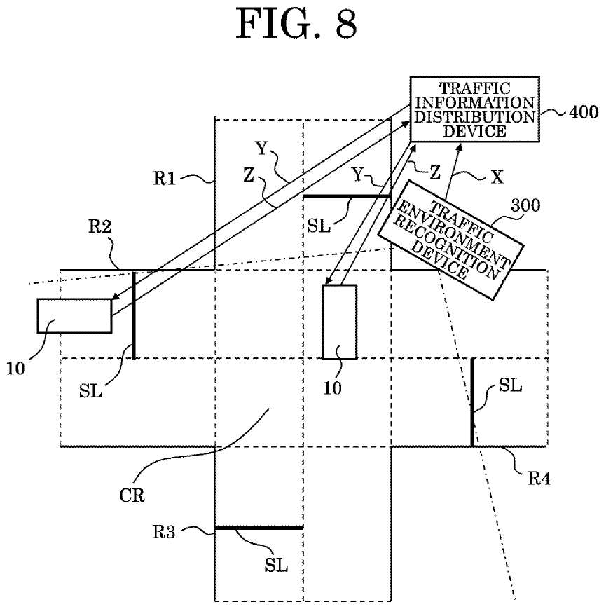

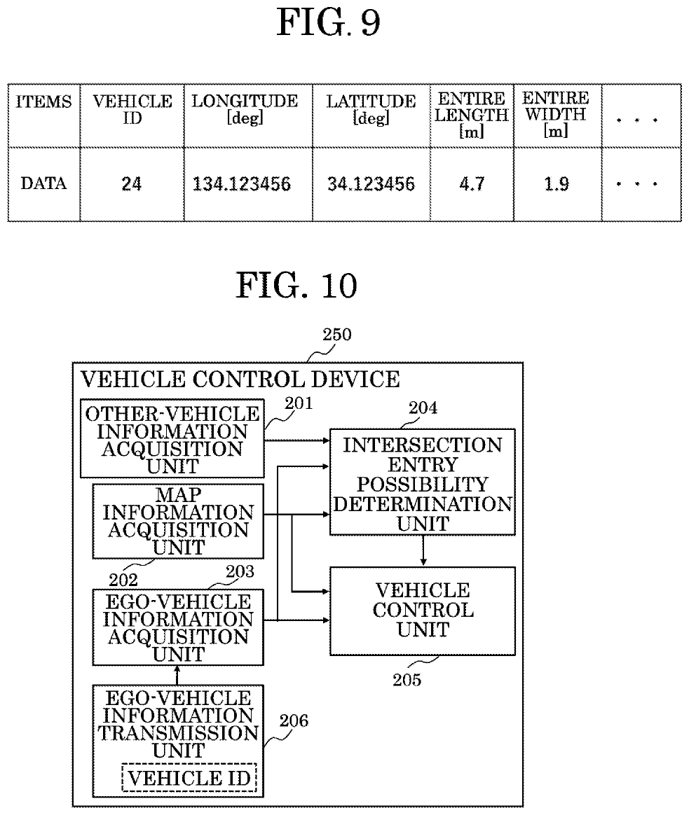

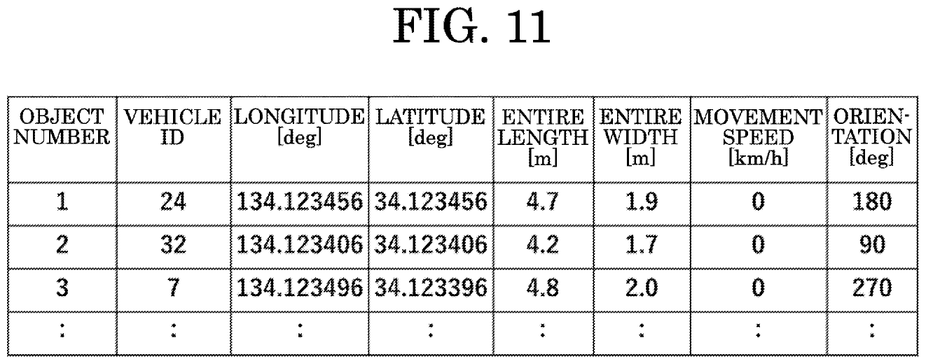

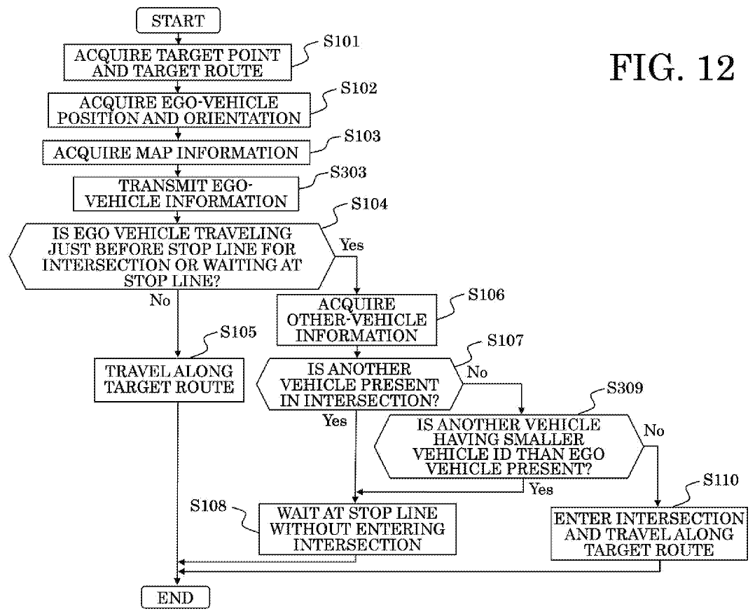

A vehicle control device, an autonomous distributed traffic control system, and a vehicle control method according to the third embodiment of the present disclosure will be described with reference to FIG. 8 to FIG. 12. FIG. 8 is a conceptual diagram showing an autonomous distributed traffic control system 1100 according to the third embodiment. FIG. 9 shows an example of the ego-vehicle information Z acquired by a vehicle control device 250 according to the third embodiment. FIG. 10 is a function block diagram showing the configuration of the vehicle control device 250 according to the third embodiment. FIG. 11 shows an example of the other-vehicle information Y acquired by the vehicle control device 250 according to the third embodiment. FIG. 12 is a flowchart illustrating the vehicle control method according to the third embodiment.

### Configurations of Vehicle Control Device and Autonomous Distributed Traffic Control System According to Third Embodiment

In the autonomous distributed traffic control system 1100 according to the third embodiment, the configuration of the autonomous distributed traffic control system 1000 according to the first embodiment is included and in addition, each autonomous driving vehicle 10 has a function of transmitting the ego-vehicle information Z to the traffic information distribution device 400. As shown in FIG. 9, in the autonomous distributed traffic control system 1100 according to the third embodiment, the ego-vehicle information Z transmitted from each autonomous driving vehicle 10 includes vehicle identification information (hereinafter, referred to as vehicle ID) for identifying the vehicle and information about the latitude and longitude representing the ego-vehicle position of the vehicle at present. Besides, the ego-vehicle information Z also includes information about the body shape such as the entire length and the entire width of the vehicle.

FIG. 10 is a function block diagram showing the configuration of the vehicle control device 250 according to the third embodiment. The vehicle control device 250 according to the third embodiment further includes an ego-vehicle information transmission unit 206 in addition to the configuration of the vehicle control device 200 according to the first embodiment. The ego-vehicle information transmission unit 206 stores, in advance, the vehicle ID for identifying each vehicle controlled by the autonomous distributed traffic control system 1100, as the ego-vehicle information Z. The ego-vehicle information transmission unit 206 acquires the ego-vehicle position from the ego-vehicle information acquisition unit 203 and transmits the ego-vehicle information Z as shown in FIG. 9 to the traffic information distribution device 400.

In the configuration example of the vehicle control device 250 according to the third embodiment shown in FIG. 10, the vehicle ID is stored in the ego-vehicle information transmission unit 206. However, within the vehicle control device 250, the vehicle ID may be stored in a part other than the ego-vehicle information transmission unit 206. Alternatively, within the ego vehicle, the vehicle ID may be stored in a part other than the vehicle control device 250.

The other-vehicle information Y distributed to the autonomous driving vehicle 10 from the traffic information distribution device 400 composing the autonomous distributed traffic control system 1100 according to the third embodiment includes the vehicle IDs corresponding to the respective other vehicles as shown in FIG. 11. The traffic information distribution device 400 associates the ego-vehicle information Z of each autonomous driving vehicle 10 individually received from the autonomous driving vehicle 10 and the traffic information X transmitted from the traffic environment recognition device 300, in accordance with the position of each autonomous driving vehicle 10, thereby generating the other-vehicle information Y to be distributed.

### Operations of Vehicle Control Device and Autonomous Distributed Traffic Control System According to Third Embodiment

In the autonomous distributed traffic control system 1100 according to the third embodiment, operation when the autonomous driving vehicle 10 travels along the target route including the intersection CR to the target point will be specifically described. FIG. 12 is a flowchart showing operation to be repeatedly executed per certain cycle by the vehicle control device 250 provided to the autonomous driving vehicle 10. In FIG. 12, the vehicle control method according to the third embodiment is different from the vehicle control method according to the first embodiment in the following two points: in the third embodiment, processing in step S303 is added between step S103 and step S104 in the first embodiment, and processing in step S109 in the first embodiment is replaced with step S309 in the third embodiment. Only processing in step S303 and step S309 will be described below.

After the target point and the target route, the ego-vehicle position and the orientation, and the map information M are acquired, in step S303, the ego-vehicle information transmission unit 206 transmits the ego-vehicle information Z as shown in FIG. 9 to the traffic information distribution device 400.

In step S309, in a case where, in the recognition range S of the traffic environment recognition device 300, the ego vehicle is traveling to the stop line SL for the intersection CR or is stopped or waiting at the position of the stop line SL and where another vehicle is not present in the intersection CR, the intersection entry possibility determination unit 204 determines whether or not another vehicle having a smaller vehicle ID than the ego vehicle is present, on the basis of the map information M, the ego-vehicle information Z, and the other-vehicle information Y.

If another vehicle having a smaller vehicle ID than the ego vehicle is present (in case of Yes), the process proceeds to step S108 and the vehicle control device 250 performs vehicle control so that the ego vehicle waits at the position of the stop line SL without entering the intersection CR, thus ending the process. On the other hand, if another vehicle having a smaller vehicle ID than the ego vehicle is not present (in case of No), the process proceeds to step S110 and the vehicle control device 250 performs vehicle control so that the ego vehicle enters the intersection CR and travels along the target route to the target point, thus ending the process.

All the autonomous driving vehicles 10 controlled by the autonomous distributed traffic control system 1100 operate as described above, whereby, at the intersection, the vehicles can enter the intersection CR in the order from the vehicle having a smaller vehicle ID. Thus, smooth traffic at the intersection can be achieved.

In the above description, it is assumed that, the smaller the vehicle ID is, the higher the priority is. However, conversely, it is also possible to assume that, the greater the vehicle ID is, the higher the priority is, as long as arrangement is made in advance in the autonomous distributed traffic control system 1100. In essence, the vehicle IDs of the vehicles may be set in advance in accordance with the order of the vehicles to be more prioritized in traffic.

In the third embodiment, the ego-vehicle information Z including the vehicle ID is transmitted from each autonomous driving vehicle 10 to the traffic information distribution device 400. Alternatively, for example, with a number plate attached to an outer part of the body of the autonomous driving vehicle 10, the traffic environment recognition device 300 may directly recognize the vehicle ID using a sensor or the like. In this case, it becomes unnecessary to transmit the ego-vehicle information Z from the autonomous driving vehicle 10 to the traffic information distribution device 400, thus providing an effect of simplifying the configuration of the autonomous distributed traffic control system.

Still alternatively, for example, the traffic information distribution device 400 may merely assign the respective vehicles with random numerical values that do not overlap each other, as vehicle IDs, whereby it is possible to avoid collision between the vehicles at the intersection or falling into deadlock.

In the third embodiment, the vehicle IDs are used as entry priorities for the intersection CR. Alternatively, the number of occupants of the ego vehicle may be included in the ego-vehicle information Z to be transmitted from the autonomous driving vehicle 10 to the traffic information distribution device 400, and the above number of occupants may be included also in the other-vehicle information Y to be distributed from the traffic information distribution device 400 to the autonomous driving vehicles 10. Then, for example, at the intersection CR, the vehicles may be allowed to enter the intersection CR in the order from the vehicle having more occupants, i.e., preferentially from the vehicle having more occupants, whereby person transfer efficiency in the autonomous distributed traffic control system can be enhanced.

### Effects of Third Embodiment

As described above, with the vehicle control device, the vehicle control method, and the autonomous distributed traffic control system according to the third embodiment, in traveling of vehicles at an intersection, whether or not the ego vehicle is allowed to enter the intersection is determined on the basis of the vehicle IDs for identifying the vehicles, whereby the vehicles can enter the intersection in accordance with the order determined by the vehicle IDs. Thus, an effect of achieving smooth traffic at the intersection is provided.

The above description of the embodiments has shown the examples in which the vehicles enter the intersection in the order based on the stop times of the vehicles in the first embodiment, the order based on priorities of the entrances for the intersection in the second embodiment, and the order based on the vehicle IDs or the numbers of occupants of the vehicles in the third embodiment. Further, by combining the first to third embodiments as appropriate, smoother traffic at an intersection can be achieved. For example, while the stop times of the vehicles are considered most important, if a plurality of vehicles exhibit the same stop time, the vehicle having the smaller vehicle ID may be preferentially selected, or priorities of the entrances for the intersection may be used.

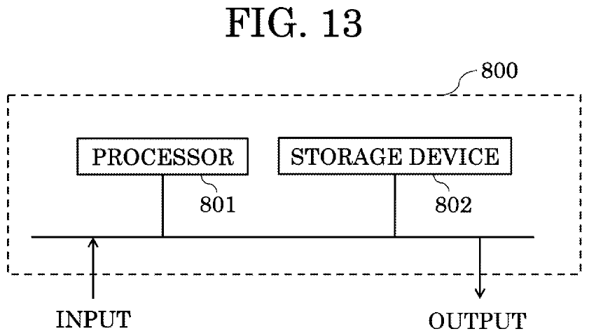

In the above description, the configurations of the vehicle control device 200, 250 and the autonomous distributed traffic control system 1000, 1100 according to each of the first to third embodiments have been described as function blocks. Meanwhile, an example of a hardware configuration for storing the vehicle control device 200, 250 and the autonomous distributed traffic control system 1000, 1100 is shown in FIG. 13. Hardware 800 includes a processor 801 and a storage device 802. The storage device 802 is provided with a volatile storage device such as a random access memory and a nonvolatile auxiliary storage device such as a flash memory, which are not shown.

Instead of the flash memory, an auxiliary storage device of a hard disk may be provided. The processor 801 executes a program inputted from the storage device 802. In this case, the program is inputted from the auxiliary storage device via the volatile storage device to the processor 801. The processor 801 may output data such as a calculation result to the volatile storage device of the storage device 802, or may store such data into the auxiliary storage device via the volatile storage device.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

10 autonomous driving vehicle

200, 250 vehicle control device

201 other-vehicle information acquisition unit

202 map information acquisition unit

203 ego-vehicle information acquisition unit

204 intersection entry possibility determination unit

205 vehicle control unit

206 ego-vehicle information transmission unit

240 actuator unit

300 traffic environment recognition device

400 traffic information distribution device

800 hardware

801 processor

802 storage device

1000, 1100 autonomous distributed traffic control system

What is claimed is:

1. A vehicle control device comprising at least one processor configured to implement:
an ego-vehicle information acquirer which acquires ego-vehicle information including at least an ego-vehicle position;
a map information acquirer which acquires map information about an intersection;
an other-vehicle information acquirer which acquires other-vehicle information about another vehicle traveling on a road connected to the intersection, in a preset range from the intersection;
an intersection entry possibility determinator which calculates a stop time of the other vehicle at a position of a stop line for the intersection on the basis of the map information and the other-vehicle information, calculates a stop time of the ego vehicle at a position of a stop line for the intersection on the basis of the ego-vehicle position, and determines whether or not the ego vehicle is allowed to enter the intersection on the basis of the stop time of the other vehicle and the stop time of the ego vehicle; and
a vehicle controller which controls traveling of the ego vehicle at the intersection on the basis of the determination by the intersection entry possibility determinator.

2. The vehicle control device according to claim 1, wherein
when the other vehicle is not present in the intersection and the stop time of the other vehicle is shorter than the stop time of the ego vehicle, the intersection entry possibility determinator determines that the ego vehicle is to enter the intersection.

3. The vehicle control device according to claim 1, wherein
when the other vehicle is present in the intersection or when the stop time of the other vehicle is longer than the stop time of the ego vehicle, the intersection entry possibility determinator determines that the ego vehicle is to wait at the position of the stop line for the intersection.

4. The vehicle control device according to claim 1, wherein
the other-vehicle information includes at least a position and a traveling speed of the other vehicle, and the stop time of the other vehicle is calculated on the basis of the position and the traveling speed of the other vehicle.

5. A vehicle control device comprising at least one processor configured to implement:
an ego-vehicle information acquirer which acquires ego-vehicle information including at least an ego-vehicle position and an orientation;
a map information acquirer which acquires map information about an intersection;
an other-vehicle information acquirer which acquires other-vehicle information about another vehicle traveling on a road connected to the intersection, in a preset range from the intersection;
an intersection entry possibility determinator which, when the other vehicle is not present in the intersection and the other vehicle is traveling to a stop line or is stopped at a position of the stop line in the preset range from the intersection, determines whether or not the ego vehicle is allowed to enter the intersection, by comparison between an entry priority of an entrance for entering the intersection from a road on which the ego vehicle travels and an entry priority of an entrance for entering the intersection from a road on which the other vehicle travels; and
a vehicle controller which controls traveling of the ego vehicle at the intersection on the basis of the determination by the intersection entry possibility determinator.

6. The vehicle control device according to claim 5, wherein
the entry priorities are respectively set in advance for each entrance to the intersection from the road connected to the intersection.

7. A vehicle control device comprising at least one processor configured to implement:
an ego-vehicle information acquirer which acquires ego-vehicle information including at least an ego-vehicle position and an orientation;
a map information acquirer which acquires map information about an intersection;
an other-vehicle information acquirer which acquires other-vehicle information about another vehicle traveling on a road connected to the intersection, in a preset range from the intersection;
an ego-vehicle information transmitter which transmits the ego-vehicle information;
an intersection entry possibility determinator which, when the other vehicle is not present in the intersection and the other vehicle is traveling to a stop line or is stopped at a position of the stop line in the preset range from the intersection, determines whether or not the ego vehicle is allowed to enter the intersection, on the basis of vehicle identification information included in each of the ego-vehicle information and the other-vehicle information; and
a vehicle controller which controls traveling of the ego vehicle at the intersection on the basis of the determination by the intersection entry possibility determinator.

8. The vehicle control device according to claim 7, wherein
the larger or the smaller a number composing the vehicle identification information is, the higher a priority for entry to the intersection is.

9. The vehicle control device according to claim 8, wherein
the vehicle identification information is composed of a random number.

10. The vehicle control device according to claim 1, wherein
the other-vehicle information acquirer acquires the other-vehicle information via a traffic information distribution device provided around the intersection.

11. An autonomous distributed traffic control system comprising:
the vehicle control device according to claim 1;
a traffic environment recognition device which is provided around the intersection and acquires traffic information about each vehicle traveling on the road connected to the intersection in the preset range from the intersection; and
a traffic information distribution device which is provided around the intersection, receives the traffic information transmitted from the traffic environment recognition device, and distributes, to each vehicle, vehicle information about the respective vehicles generated on the basis of the traffic information.

12. The autonomous distributed traffic control system according to claim 11, wherein
each vehicle is an autonomous driving vehicle.

13. A vehicle control method comprising:
acquiring ego-vehicle information including at least an ego-vehicle position;
acquiring map information about an intersection;
acquiring other-vehicle information about another vehicle traveling on a road connected to the intersection, in a preset range from the intersection;
calculating a stop time of the other vehicle at a position of a stop line for the intersection on the basis of the map information and the other-vehicle information, calculating a stop time of the ego vehicle at a position of a stop line for the intersection on the basis of the ego-vehicle position, and when the other vehicle is not present in the intersection and a stop time of the other vehicle is shorter than a stop time of the ego vehicle, determining that the ego vehicle is to enter the intersection; and
controlling traveling of the ego vehicle at the intersection on the basis of the determination in the intersection entry possibility determination step.

14. A vehicle control method comprising:
acquiring ego-vehicle information including at least an ego-vehicle position and an orientation;
acquiring map information about an intersection;
acquiring other-vehicle information about another vehicle traveling on a road connected to the intersection, in a preset range from the intersection;
determining whether or not the ego vehicle is allowed to enter the intersection, by comparison between an entry priority of an entrance for entering the intersection from a road on which the ego vehicle travels and an entry priority of an entrance for entering the intersection from a road on which the other vehicle travels, when the other vehicle is not present in the intersection and the other vehicle is traveling to a stop line or is stopped at a position of the stop line in the preset range from the intersection; and
controlling traveling of the ego vehicle at the intersection on the basis of the determination in the intersection entry possibility determination step.

15. A vehicle control method comprising:
acquiring ego-vehicle information including at least an ego-vehicle position and an orientation;
acquiring map information about an intersection;
acquiring other-vehicle information about another vehicle traveling on a road connected to the intersection, in a preset range from the intersection;
transmitting the ego-vehicle information;
determining whether or not the ego vehicle is allowed to enter the intersection, on the basis of vehicle identification information included in each of the ego-vehicle information and the other-vehicle information, when the other vehicle is not present in the intersection and the other vehicle is traveling to a stop line or is stopped at a position of the stop line in the preset range from the intersection; and
controlling traveling of the ego vehicle at the intersection on the basis of the determination in the intersection entry possibility determination step.

16. The vehicle control method according to claim 15, wherein
the larger or the smaller a number composing the vehicle identification information is, the higher a priority for entry to the intersection is.

17. The vehicle control method according to claim 16, wherein
the vehicle identification information is composed of a random number.
